(19) United States
(12) Patent Application Publication
(10) Pub. No.: US 2017/0060856 A1
(43) Pub. Date: Mar. 2, 2017

(54) EFFICIENT SEARCH AND ANALYSIS BASED ON A RANGE INDEX

(71) Applicants: HOWARD TURTLE, JACKSON, WY (US); VASANTHAKUMAR R. SAKREPATNA, NASHUA, NH (US); ROBERT C. COOK, SUNDERLAND, MA (US)

(72) Inventors: HOWARD TURTLE, JACKSON, WY (US); VASANTHAKUMAR R. SAKREPATNA, NASHUA, NH (US); ROBERT C. COOK, SUNDERLAND, MA (US)

(73) Assignee: Chiliad Publishing Incorporated, Herndon, VA (US)

(21) Appl. No.: 12/635,693

(22) Filed: Dec. 10, 2009

Related U.S. Application Data
(60) Provisional application No. 61/121,411, filed on Dec. 10, 2008.

(51) Int. Cl. G06F 17/30

(52) U.S. Cl. CPC G06F 17/30

(57) ABSTRACT

The present invention relates to searching documents based on a range index. A range index may comprise range-searchable elements having explicit data types, such as integers, real numbers, geographic locations, dates, times, etc. The data type determines what operators can be used in expressions. Each element of the range index corresponds to an occurrence of an item in the document collection that satisfies the range expression. In addition, range indexes can be aggregated into a set of aggregate indexes to facilitate evaluation. Aggregation may depend on the field's type or the distribution of values. For example, date fields might have a range indexed by day, by month at one level, and then by year at another level. Thus, these new file structures and evaluation techniques result in a new inverted list structure that allows efficient query evaluation using expressions that operate on typed data.

### CROSS-REFERENCE TO RELATED APPLICATIONS

This application claims the benefit of priority to U.S. Provisional Application No. 61/121,411, filed Dec. 10, 2008, which is hereby incorporated by reference in its entirety.

### FIELD OF INVENTION

This disclosure generally relates to indexing, searching, analyzing and filtering data. More specifically, this disclosure relates to decentralized indexing, search, analysis and filtering of different types of data, including sub-document analysis.

### BACKGROUND

Generally described, the information stovepipe problem prevents entities, such as corporations, governments, and the like from taking full advantage of information distributed across their enterprises and beyond. Unfortunately, there is little to no existing technology to connect this information across so many incompatible systems and organizations to discover threats and alert in real time.

For these and other reasons, considerable efforts have been made to solve the information stovepipe problem. Typically, these efforts treat structured data, such as data stored in database management systems, differently than unstructured data, such as documents in a file system. Unfortunately, treating disparate data types differently limits search and analysis because the most relevant items cannot be determined.

In addition, these technologies have other drawbacks related to poor integration among the different stovepipes. For example, each stovepipe may need separate authentication to be accessed, separate queries to be written to find relevant data, and separate alerts to be written to discover newly available data. Different stovepipes may generate separate search results that are difficult to correlate with each other. These shortcomings can be especially significant in time sensitive situations, where simultaneous analysis and selection of the most relevant documents across all stovepipes, such as distributed data repositories, is needed.

These and other challenges have made the search and analysis of distributed repositories of disparate data a difficult technology to reliably implement.

### SUMMARY

The present invention relates to searching documents based on a range index. A range index may comprise range-searchable elements having explicit data types, such as integers, real numbers, geographic locations, dates, times, etc. The data type determines what operators can be used in expressions. Each element of the range index corresponds to an occurrence of an item in the document collection that satisfies the range expression. The use of the term ‘field’ in this context of named field can also include data types that can be recognized in full text In addition, range indexes can be aggregated into a set of aggregate indexes to facilitate evaluation. Aggregation may depend on the field's type or the distribution of values. For example, date fields might have a range indexed by day, by month at one level, and then by year at another level. Thus, these new file structures and evaluation techniques result in a new inverted list structure that allows efficient query evaluation using expressions that operate on typed data.

In one embodiment, a computer-implemented method of indexing content in a document collection, wherein a set of elements are defined for the document collection and each element comprises at least one field having a range of terms, and the method comprises: determining a first inverted index that indicates a list of terms belonging to a field and respective documents in the document collection; and determining a second inverted index that aggregates at least a portion of the range of terms into a list of aggregate terms belonging to the field and respective documents in the collection.

In another embodiment, a method of searching for information in a document collection, wherein a set of elements are defined for the document collection and each element comprises a field having a range of terms and a specified data type, and the method comprises: receiving a query for information from the document collection; accessing, based on a range expression that is compliant with the data type, at least one index that indicates a list of terms belonging to the field and respective documents in the document collection; and providing a set of results based on the index.

### BRIEF DESCRIPTION OF THE FIGURES

The invention will be described in conjunction with the following drawings in which like reference numerals designate like elements. In the Figures:

FIG. 1 shows an exemplary system of the present invention.

FIG. 2 illustrates an exemplary indexing process.

FIGS. 3A-D illustrate an exemplary search process.

### DESCRIPTION OF THE EMBODIMENTS

The present disclosure relates to systems and methods that integrate and fuse data from distributed sources into useful knowledge. The embodiments employ a novel peer-to-peer architecture for search, analysis, knowledge discovery and fusion, and monitoring and alerting capabilities.

A general overview of the peer-to-peer architecture is first provided. Next, an overview of several significant analysis functions of the embodiments is provided. Finally, further information is provided regarding various details of the architecture, data structures, and processes. An overview of the architecture will now be provided.

Overview of Peer-to-Peer Architecture and its Benefits

The cooperative peer-to-peer processing architecture of the embodiments employs nodes that are distributed across an organization. An organization can distribute these nodes to provide instances for search, indexing and analysis engines. The nodes work in conjunction as a network of cooperating nodes across local or remote distributed networks and provides high availability and fault tolerance. Each instance of the node can be implemented on any type of host system or data device using any operating system and hardware platform. Together, the nodes effectively establish a single, virtual computer system that is capable of searching and analyzing results in parallel across multiple networks, domains, hosts, and data repositories. Thus, from the user's perspective, the embodiments provide for global knowledge fusion of distributed data as if it were in a single repository and may provide various analytic tools that take advantage of this global knowledge fusion.

Each node may serve as a federator or provider. As a federator, a node handles query interaction with a user. As a provider, a node handles executing search requests. With appropriate access permissions, any node can query any combination of other nodes on the fly, and a node can function both as a federator and a provider simultaneously. The nodes employ optimized network communications to ensure that they can cooperate with minimal network load.

There are many benefits of the distributed architecture employed by the embodiments of the present invention. Multi-host connectivity of the nodes allows organizations to distribute processing in parallel among federated nodes across local or remote distributed networks. Document collections can remain in-place and do not need to be duplicated, managed on a central server, or sent across networks for indexing and analysis. Network traffic can be kept to a minimum because documents are only transferred across the network when needed. Searching is applied to the most up-to-date information because collections are managed locally and can be searched from any location. Processing load is distributed across all of the participating nodes, so users experience high performance even with large collections of documents or records. Organizations can quickly integrate diverse collections across different operating environments. Users can analyze data from a wide range of distributed collections simultaneously, which reveals relationships that would otherwise go undetected.

Using the distributed architecture of the present invention, organizations that have existing investments in search engines, content management systems and databases don't need to remove or change those applications. The embodiments can index content without disrupting those systems, and can even perform analysis on items retrieved from those systems using its federation capabilities.

The flexibility of the architecture of the present invention allows for handling of documents in virtually any file format, file systems, messages, data feeds (such as RSS, HTML), and database management systems. Of course, other benefits of the distributed architecture may be apparent to those skilled in the art.

Some Analysis Functions of the Embodiments

As noted, the present invention can provide a wide variety of novel analysis functions. For example, the embodiments can provide at least the following analysis functions: (1) distributed search; (2) real-time, on-the-fly analysis; (3) concept and entity extraction; (4) knowledge discovery; (5) information navigation and presentation; and (6) monitoring and alerting. Each of these will now be briefly described below.

Distributed Search

As noted, the embodiments provide a comprehensive distributed search capability that works seamlessly across large amounts of structured and unstructured data and consistently delivers quality results. The embodiments can monitor and search across both intranet and Internet web sites. Flexible application programming interfaces (APIs) allow integration and secure searching of data managed in any content repository.

Most conventional systems are optimized for precision at the expense of recall because the underlying technology is not discerning enough to do both and still avoid false positives. This usually means some critically important information can be missed. Fortunately, the distributed search of the embodiments can provide both precision and recall using efficient merging techniques. A wide range of search methods are available, including: natural language; concept-based; Boolean and normalized regular expressions; proximity; synonym-matching; “fuzzy” or approximate term matching; and geo-referenced, and data-typed queries.

Unlike conventional search systems, the distributed search of the present invention is not limited searching to a particular mode such as Boolean or natural language. Instead, the embodiments allow users to construct a query (or an alert) using a variety of styles simultaneously and uses the combined criteria to perform the search or analysis. In addition, in some embodiments, there is no need for end users to learn a search language or syntax.

The distributed search of the present invention is also configured to bridge between structured and unstructured data. In particular, traditional search engines treat structured data stored in database management systems as “metadata,” separate from unstructured documents. In contrast, the embodiments can perform search and analysis across both types of data, regardless of location and format, and with no limits on what constitutes a “document.”

One significant challenge to conventional search is data access and security. The distributed search of the present invention can efficiently search and analyze across enormous repositories of geographically distributed unstructured and structured data as if all the resources were in a single repository on the user's own computer. Unlike the typical scenario where users have to log in and authenticate in each stovepipe application, the embodiments can provide a sophisticated security layer with single sign-on for simultaneous access across all of the resources that a user is authorized to view. For example, the embodiments may employ Lightweight Directory Access Protocol (LDAP) and other industry-standard methods for secure sign-on and authentication. In addition, the embodiments can also support secure information sharing among domains with differing security levels, enabling true information sharing.

Real-Time, On-the-Fly Analysis

The embodiments of the present invention perform sophisticated analysis, for example, at the document and the sub-document level. This analysis is used to mine the data and identify concepts and entities. Of note, unlike conventional systems, the embodiments use the user's query as the context of the analysis on the fly and in real-time, if needed. In contrast, conventional technologies only identify concepts at the time of indexing and rely on static definitions of a concept.

There are several benefits to performing concept recognition in accordance with the present invention. For example, the topics presented with the user's search results are weighted and ranked based on their relationship to the user's query and area of interest and most relevant part of the document that matched the user's query from the fused result set. In that way users are not overwhelmed with large numbers of concepts that are not pertinent to their investigation or search, while still receiving a comprehensive list of concepts that are tightly associated with the user's query. Also, using different visualization techniques to display such associations by representing different display options for different types of concepts, it enables users to effectively analyze and find relationships.

As organizations add or refine their inventory of concept recognizers, these changes are immediately propagated and applied in future inquiries. Consequently, each user's results include concepts based on the most up-to-date rules, not the rules that were in effect at the time the documents were originally processed and indexed. Furthermore, concepts extracted from retrieved items at query time can be used as valuable metadata for further discovery and fusion with other data.

Concept and Entity Recognition

Most search and text mining systems extract concepts and entities, such as people, places, organizations and other definable things from unstructured text at the time new items are processed and indexed. The embodiments of the present invention take a more comprehensive approach and automatically recognize a wide variety of types of concepts and entities during search and analysis time. In addition, the embodiments are extensible so new concept recognizers can be added at any time.

As noted, the embodiments can perform concept recognition dynamically, at query and analysis time, to provide users with the most contextually relevant concepts focused on the most relevant portion of each document. For example, concepts can include phrases, such as “hostile takeover” or “leveraged buyout,” key data, such as account numbers or email addresses, or might take the form of entities such as people, places and organizations. Thus, the embodiments may use concepts to provide important metadata for analyzing the content of a group of items, for conceptually navigating search results, for filtering new content, and for connecting structured and unstructured data sets.

Knowledge Discovery

When a user performs a search or other action that creates a fused result set, the embodiments can provide a knowledge discovery service. In one application, this service uses the important, contextually relevant concepts to construct a fused hierarchical knowledge map for the user to browse and explore. This knowledge map structure can be very efficient for finding information about a specific topic, but more importantly, as the user navigates through the knowledge map, connections among key concepts come into focus more clearly, helping to discover previously unknown connections.

Knowledge discovery may also result from tracking user behavior and allowing collaboration among users. For example, as users retrieve, analyze and browse documents, the embodiments can optionally log and track the knowledge that each user has accessed. This information can be used to identify experiential experts and individuals with whom to exchange tacit information. This capability can be combined with filtering agents to also monitor data in real-time and provide an input for alerts.

Navigation and Presentation of Results

In some embodiments, a web browser interface may be employed that guides users as they build and save queries and refine and explore fused search results from widely distributed heterogeneous datasets. The web-based interface may also be customizable, thus allowing each organization to add their own style and identity to the user's view, and even to modify or add functionality.

The embodiments may also provide merged/fused faceted navigation that provides the ability to rapidly organize documents and other records based on metadata and/or data elements including concepts from structured databases or extracted from unstructured documents. For example, a manager searching a database of resumes for candidates to staff a project might start a search by retrieving all of the Java programmers in the system. This user might then use faceted navigation to explore and analyze the result set, experimenting with different facets of the candidates such as years of experience, location, security clearance, current assignment status, willingness to travel, etc. With each click on a facet, the result set may be reduced until only results that meet all of the requirements are left.

Faceted navigation gives the searcher the ability to quickly and interactively see how each qualifier affects the result list. Faceted navigation takes full advantage of distributed architecture to enable browsing and analysis across all selected repositories.

Location is a powerful organizing concept for presenting information. Accordingly, the embodiments may provide a geospatial service that enables the display of data, such as entities and search results, on a map. This service can use location information extracted from unstructured or structured content such as city, state or zip code, enabling users to see geographic information in a graphical way to help see patterns or make connections that might not otherwise be obvious. In some embodiments, an embedded geocoder module can assign latitude/longitude properties to geographic entities and other items so that those items, and/or the documents in which they were referenced, can be displayed in a variety of geographic map interfaces. In addition, the embodiments may employ any of a variety of commercial mapping and geospatial analysis tools, including ESRI and Google Earth™. For example, the embodiments may be integrated with a variety of commercial visualization, mapping and analysis tools, including ESRI, Google Earth™ and i2/ChoicePoint.

Monitoring and Alerting

Reliable and accurate filtering of new data can be of critical importance to many organizations. The embodiments can provide a comprehensive and scalable system available for tracking and receiving alerts about new data in real time. In some embodiments, filtering agents of a filtering engine are used that are similar to queries executed against each incoming item; but filtering occurs instantly on new items before indexing to provide the highest performance, scalability and timeliness.

In some embodiments, the alerting system can operate in two modes: batch or stream. In batch mode, the system will filter periodically in batch processes against newly acquired data. In stream mode, the alerting service can be configured to filter streaming data instantly as each document or message arrives live over a network. Adaptive analysis is employed to exploit any new bits of field data within seconds of arrival to enable immediate response, if needed.

The filtering engine can make use of the entire range of search, analysis, and selection capabilities for ranking and thresholding, as well as ad-hoc analysis across distributed networks, thus assuring users that important items will not be missed, and that false positives can be eliminated. A wide range of filtering methods are available, including: natural language; concept-based; Boolean and normalized regular expressions; proximity; synonym-matching; “fuzzy” or approximate term matching; geo-referenced; and data-typed queries. The filtering engine can be deployed at each node so that users can monitor new information anywhere in the extended system, and if desired, this information can be tailored based on how it is handled by the node.

Filtering agents can include a relevance threshold, which specifies the relevance level that is required before an actual alert is generated. Users may choose immediate notification, periodic updates (such as daily or weekly), and also view alerts in a client application.

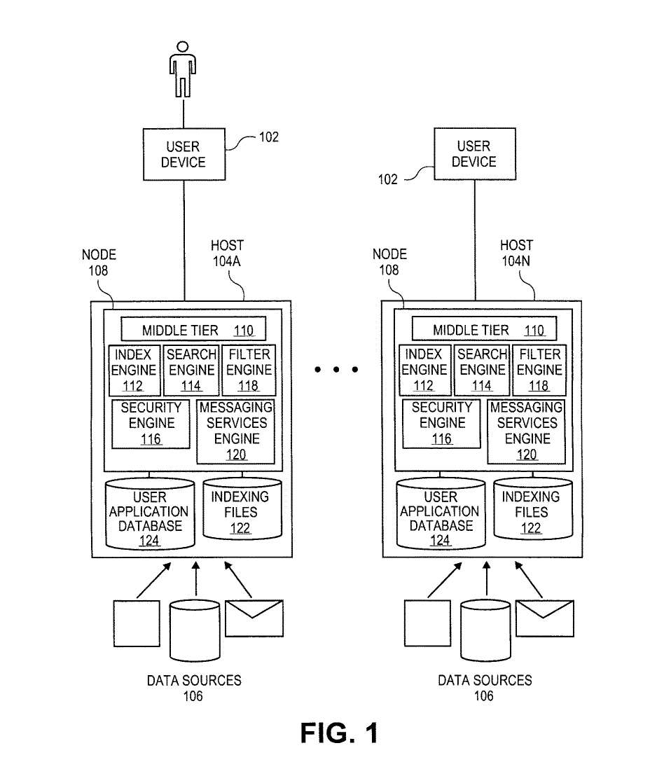

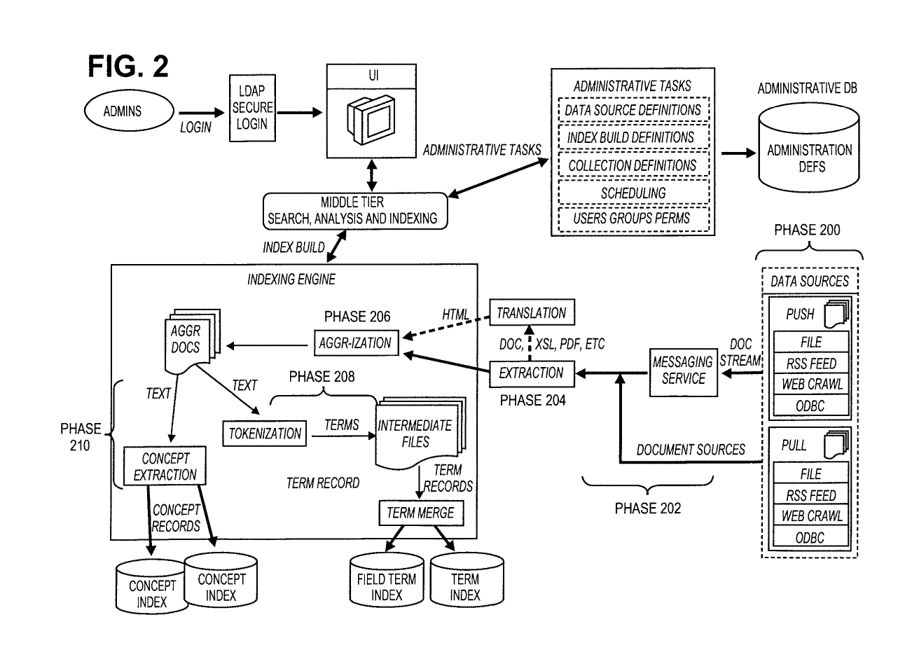

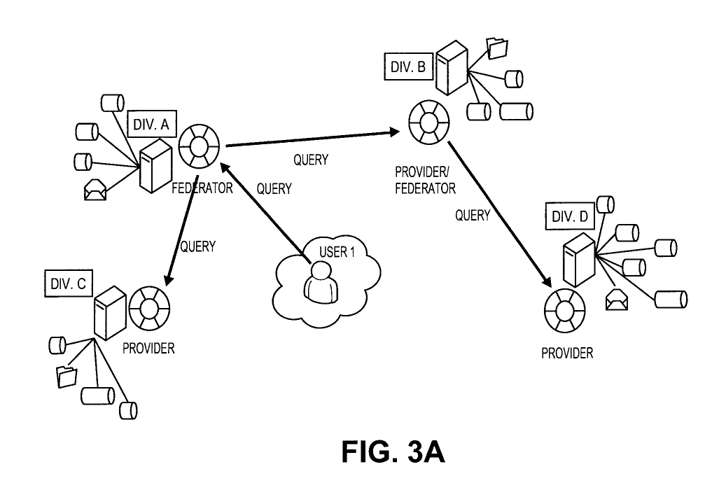

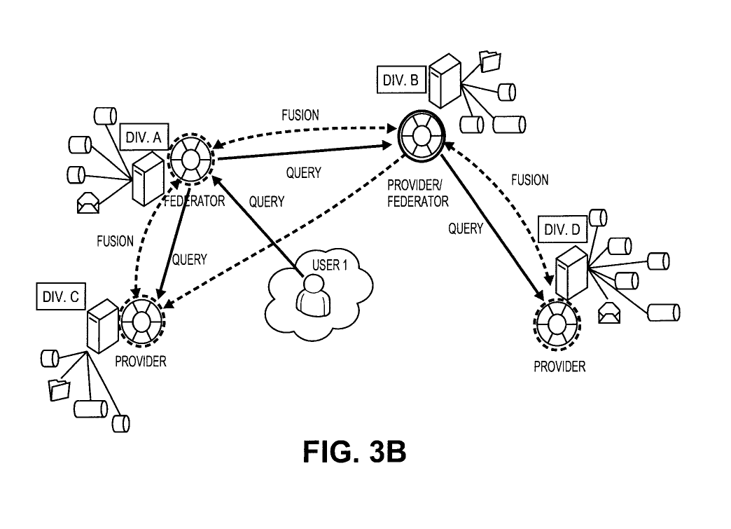

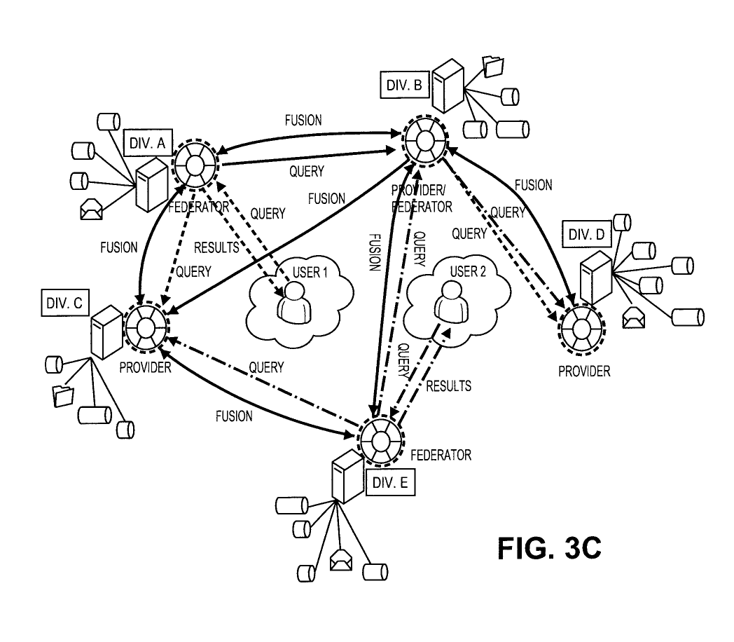

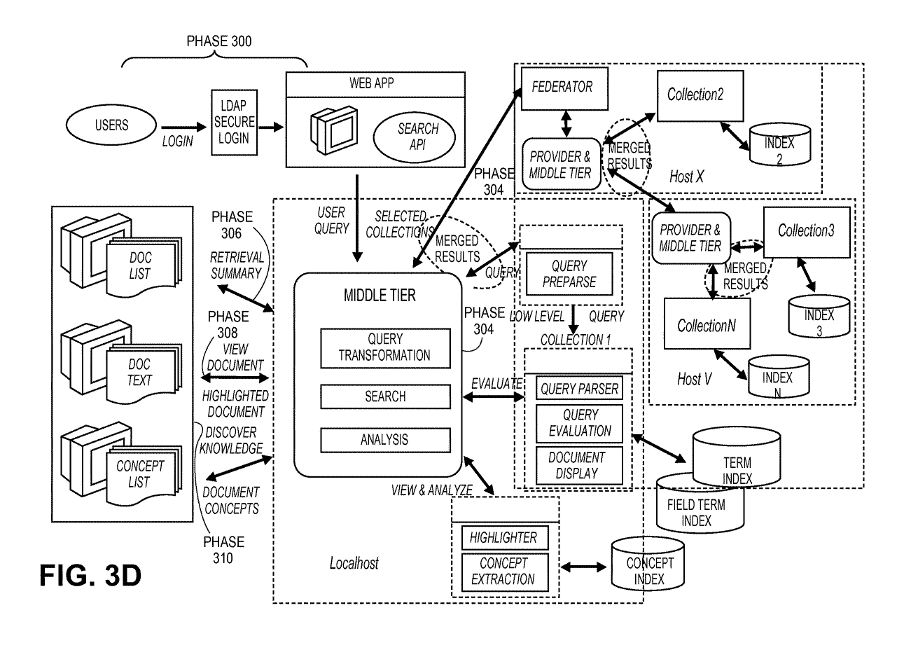

Embodiments of the disclosure will now be described with reference to the accompanying figures, wherein like numerals refer to like elements throughout. FIG. 1 shows an exemplary system of the present invention. FIG. 2 illustrates an exemplary indexing process. FIGS. 3A-D illustrate an exemplary search process.

The terminology used in the description presented herein is not intended to be interpreted in any limited or restrictive manner, simply because it is being utilized in conjunction with a detailed description of certain specific embodiments of the invention. Furthermore, embodiments of the invention may include several novel features, no single one of which is solely responsible for its desirable attributes or which is essential to practicing the inventions herein described.

System Overview

FIG. 1 shows one embodiment of a system that is consistent with the present invention. As shown, the system 100 may comprise user devices 102, hosts 104, data sources 106, and nodes 108 as its main components. These components may be coupled together by various communication links (not shown) and networks (not shown). Each of these components will now be briefly described.

User Device

User device 102 provides the hardware and software infrastructure for a user to interface with the system 100. For example, the user device 102 may be a computing system, mobile device, keypad, card reader, biometric data reader, or other device that allows a user, to exchange information with the plurality of hosts 104A-N. In particular, user device 102 may include a client application, such as a web browser, thin client, or installed application, that allows the user to search the plurality of hosts 104A-N and display the results of the search. In addition, the user device 102 may include a keypad or biometric data reader that allows the user to enter in verification information.

The user devices 102 may typically include one or more commonly available input/output (I/O) devices and interfaces, such as a keyboard, mouse, touchpad, and printer. In one embodiment, the I/O devices and interfaces 110 include one or more display device, such as a monitor, that allows the visual presentation of data to a user. More particularly, a display device provides for the presentation of GUIs, application software data, and multimedia presentations, for example. User devices 102 may also include one or more multimedia devices, such as speakers, video cards, graphics accelerators, and microphones, for example.

For example, user devices 102 may provide an application for secure LDAP login for system access. For those users having administrative rights, this application may be configured to provide administrators access to system administrative functions. Administrators, for example, will define system collections, data sources, accounts, build indexes, and the like. For typical users, the application generally provides user search capabilities across multiple document collections and hosts and user alert filtering capabilities.

Hosts

The hosts 104A-N comprise one or more computer systems that host and make available data in various formats, including email, web pages, streaming data feeds, structured databases, unstructured databases, file systems, etc. As shown, the hosts 104A-N communicate with each other via a network, such as a local area network, a wide area network, the Internet, etc. Of note, the hosts 104A-N can include various operating systems, hardware platforms, and be on different security domains.

The hosts 104A-N include, for example, a computing system, such as a computer that is IBM, Macintosh, or Linux/Unix compatible. According, the exemplary hosts 104A-N will include a central processing unit (“CPU”), which may include one or more conventional microprocessors, a memory, such as random access memory (“RAM”) for temporary storage of information, a read only memory (“ROM”) for permanent storage of information, and one or more mass storage devices, such as one or more hard drive, diskette, and/or optical media storage device.

The hosts 104A-N are generally controlled and coordinated by operating system software, such as Windows 95, Windows 98, Windows NT, Windows 2000, Windows XP, Windows Vista, Linux, SunOS, Solaris, or other compatible operating systems. In Macintosh systems, the operating system may be any available operating system, such as MAC OS X. In other embodiments, the plurality of hosts 104A-N may be controlled by a proprietary operating system. These operating systems control and schedule computer processes for execution, perform memory management, provide file system, networking, and I/O services, and provide a user interface, such as a graphical user interface (“GUI”), among other things. As shown, hosts 104A-N may provide access to respective data repositories that are coupled to data sources 106.

Data Sources

Data sources 106 can include a variety of unstructured content, structured databases, file systems, live feeds and messages, etc. The information supplied by the data repositories from data sources 106 may include information relating to government intelligence, business intelligence, financial services, legal, healthcare, aerospace, pharmaceuticals, life sciences, or law enforcement, for example. In some embodiments, the data repositories of hosts 104A-N may be interconnected by various network interconnects, communication links, or via a network, such as the Internet.

Data sources 106 are those physical entities that define where and what type of inputs will go into a defined index. Data sources can be ODBC (from defined table columns of a DBMS), the web, or files residing in a disk directory or directory tree. In general, the system 100 extracts data content from the specified source and physically puts them on disk at a system-defined node 108.

As will be described further below, data is extracted from the data sources 106. An index is then built from these data sources (after a process of “aggrization” in which the content is stripped of non-text content, such as JavaScript, formatting, etc). An index may be group of files where file source information, term statistics, field term statistics, relevant fields, etc are stored in a common directory with the index name as its name. For implementation reasons, indexes may be specific to a particular one of hosts 104A-N in some embodiments.

An index can be associated with more than one data source 106. For example, one index can have Wall Street Journal and San Jose Mercury Monitor articles as a data source, and another index could have Wall Street Journal and Washington Post articles as its data sources.

Once indexes are built, they can be grouped into collections. Collections are a logical entity comprising one or more indexes that may reside on more than one disk location or host. Peer to peer federation also allows remote collections to be added into a user's collection definition. In some embodiments, a master/slave architecture is employed to allow multiple users interact with a single set of data collections seamlessly. The master controls all access to the data sources. In these embodiments, a separate data storage machine may be used that is capable of holding large collections of data, and specializing only in the data, becomes the shared data resource for the users.

In some embodiments, one or more of the data sources 106 may comprise a relational database, such as Sybase, Oracle, CodeBase and Microsoft® SQL Server as well as other types of databases such as, for example, a flat file database, an entity-relationship database, an object-oriented database, and/or a record-based database can also be used. In addition, the data sources 106 may include one or more internal and/or external data sources.

Documents and data from data sources 106 may be introduced into the system 100 via automatic or explicit user means. For example, documents may be automatically pushed into a data repository of hosts 104A-N by placement of documents in specified directories or define directories where document are resident for explicit or scheduled index builds. Push data source documents from a data source 106 are typically document streams. Pull-type documents from a data source 106 may be more static in nature.

Documents may originate from a variety of sources. Documents may be represented as a file on a disk directory tree. Documents may be defined in an ODBC compliant database where they are created via SQL commands. Documents referenced by URLs are downloaded or crawled and stored on disk in HTML form. RSS feed documents are similar in nature to web docs.

System Nodes

Nodes 108 represent the local infrastructure of hardware and software at hosts 104A-N that are used to provide the global knowledge fusion functions of system 100. As shown, nodes 108 may comprise several main components including a middle tier 110, an indexing engine 112, a search engine 114, a security module 116, a filtering engine 118, and a messaging services engine 120.

In general, the word “module” or “engine,” as used herein, refers to logic embodied in hardware or firmware, or to a collection of software instructions, possibly having entry and exit points, written in a programming language, such as, for example, Java, Lua, C or C++. A software module or engine may be compiled and linked into an executable program, installed in a dynamic link library, or may be written in an interpreted programming language such as, for example, BASIC, Perl, or Python. It will be appreciated that software modules or engines may be callable from other modules, engines or from themselves, and/or may be invoked in response to detected events or interrupts. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules and engines described herein are preferably implemented as software modules or engines, but may be represented in hardware or firmware. Generally, the modules and engines described herein refer to logical modules that may be combined with other modules or divided into sub-modules despite their physical organization or storage.

Nodes 108 may serve different roles, such as a federator or provider, within system 100. Federators disperse queries to providers on other hosts 104A-N. Providers have access to indexes for specified collections. Providers have their own middle tiers 110 in which to provide for data flows. Query results are merged between indexes at provider nodes. These components will now be briefly described.

Middle Tier

Middle tier 110 is an infrastructure tasked with various functions including query dissemination, fusion of search and analysis results, process spawning and communication, module configuration and connectivity, and process command execution for discovery and alert processes. For example, middle tier 110 may supervise and conduct queries, document requests, highlighting and concept extractions to proper process for collection and hosting. Middle tier 110 may construct HTML result displays for user on web browser at user device 102. Middle tier 110 serves as middleware for hosts 104A-N and document collections, and provides a virtual, global index service. If middle tier 110 is within a federator node, it may disperse queries to other nodes to access multiple indexes or collections on multiple hosts 104A-N. In addition, middle tier 110 may merge the results and present them to the user via user device 102.

In some embodiments, middle tier 110 communicates with “engines” that perform actual indexing, query preprocessing, search and highlighting or concept extraction. Administration functions are also provided. Furthermore, in order to optimize the distributed architecture of system 100, middle tier communications may use strings of fairly short length, e.g., about 2000 characters or less. The length of these communication packets may be configurable.

Indexing Engine

Indexing engine 112 creates and maintains the storage representation for document, term and concept data and optimizes the indexes for efficient lookup in support of searches. Indexing engine 112 may employ the following (four) main processes. Extraction to ensure instance of each document source is physically present on system 100 for processing. Translation to convert non-text document formats (e.g. MS Word, PDF document) to text form. Tokenization to break documents into words for statistical analysis and index storage. Concept extraction to recognize concepts of interest in the text for storage to indexes.

Search Engine

Search engine 114 provides the search features for a node 108. In general, search engine 114 may employ the following processes: a parsing process to break a user query into terms and structure operations; an evaluation process to analyze the content requested by the query and determine the relevant documents; a document fetch process to fetch selected documents for user viewing; and a document highlighting process to highlight user query terms in document for user viewing.

Security Module

Security module 116 ensures that various security policies and domains are maintained by system 100. Security module 116, for example, can support authenticating users through a third party identity server, such as an LDAP server. For example, two methods of authenticating a user may be provided: (1) the user's login and password are verified against a locally stored user record on hosts 104A-N; and (2) an LDAP server is queried with the user login and password to verify that they are valid.

In general, a user may authenticate into system 100 using their same username and password to log in to the LDAP repository and to retrieve group information for the user. If the authentication against LDAP succeeds, a user account for the given username is created or updated in nodes 108. This account will have exactly the group permissions that are retrieved from the LDAP server for that user when the system 100 authenticates the user.

Optionally, however, if LDAP does not contain any record for a username, but node 108 has a record for that username, then the user will be authenticated against that account record. This can be useful, for example, to allow a local admin account to access node 108.

One of the benefits of the embodiments is that it relieves users of the time and inconvenience of sequentially logging into multiple systems to conduct a separate search in each. Accessing information from sources simultaneously also yields insights that would be difficult, if not impossible, to attain by accessing each system separately. Managing access to a distributed network of secure systems request a sophisticated security mechanism. The security module 116 is designed to deliver the convenience of single sign-on and simultaneous access while strictly enforcing access permissions at the organization, system, network domain, and application level. The security model enforced via security module 116 is designed to accommodate security requirements ranging form open access to the most secure environments.

During collection and indexing, the nodes 108 captures and preserves access permission for each item. Included in this data is information, such as which users and groups are permitted to access the item. When a user logs in, the security module 116 associated with the federator node 108 will handle the user's request handles initial authentication of the user. Using a combination of cached access credentials and other application-dependent information, system 100 can ensure that the user has access to each relevant item before presenting search results. Final access permission for each item is handled at the relevant leaf node where the request is processed to ensure compliance with the most recent permission settings. As with other operations, network traffic may be kept to a minimum, and details of the system's operation are under the control of a system administrator.

Filtering and Alert Engine

Filtering and alert engine 118 is a document filtering processor used for matching document streams against stored user “alerts” (queries) and notifying the alert owner of document “hits” (matches). Filtering engine 118 performs indexing and query evaluation processes similar to the indexing engine 112 and search engine 114. In addition, the filtering and alert engine 118 may be used for dynamic concept extraction on any document or dynamic highlighting of any document for a query.

Messaging Services

Messaging services engine 120 provide messaging services used to obtain (pull) documents or receive documents that are pushed from data sources 106. In particular, messaging services engine 120 may access data sources 106 and pull content from the respective data repositories (file system, web, relational database) to be indexed. The pull environment is most effective for indexing large amounts of archived or already existing data (producing indexes that change very little), but would not be efficient for updates to the data repositories, i.e. a stream of incoming documents.

However, in order to supplement the pull environment, messaging services engine 120 may support push documents. For example, if a few documents were added to the file system, pull data sources have to scan the whole directory. In many environments, hosts 104A-N know what documents or records are being added to the repositories. This information can be “pushed” to a particular repository for data aggregation and indexing.

Messaging services engine 120 can support pushing documents from files, databases or web references to indexing for filtering processes in several ways. First, messaging services engine 120 may employ a list watcher that watches a directory for listing files, which contain document, web page, or database record references. The names of the listing files may be of the form:

<data_source_name>-<number>1st

where “data source name” is the name of a file system, ODBC or web data source that will receive the documents, and “number” is a unique number (per data source) that can be assigned by the listing file generator.

The contents of the listing file should be of the form:

<document_reference> <[A|M|D]>

where “document reference” can be references for documents on the file system, database records, or web pages. <[A|M|D]> signifies whether the document reference is being added (A), modified (M), or deleted (D).

In addition, messaging services engine 120 may employ Web URI type references, such as http://, https://, ftp://, and file://, as well as custom URL protocols. Furthermore, messaging services engine 120 may comprise a push API to support pushing of document or database references into node 108 for indexing or filtering.

In addition, nodes 108 may comprise various files and data structures. For example, nodes 108 may comprise or be coupled to one or more indexing files 122 and a user application database 124. These data structures will now be briefly described.

Indexing Files

Indexing files 122 provide the data that holds the indexes created by the indexing engine 112 of a node 108. The indexing process is also described with reference to FIG. 2 below. In general, however, indexing by indexing engine 112 is done in three main steps: document aggregation, indexing, and concept extraction.

Document aggregation is the process of cleaning, normalizing field values, and injecting default and other external fields and creating an aggregate document that contains many documents in each file. Many such files may be created depending on the number of documents to be indexed.

The indexing process of indexing engine then uses these files to create the final index. Indexing is done in two phases: (1) document parsing and indexing and (2) merge and create the final index.

During document parsing, the aggregate files, are parsed using an and an internal in-memory document representation is created. Then this document representation is tokenized, normalized (stop/stem), and put into in-memory indexes for both text and fields. The in-memory indexes are periodically flushed into intermediate files.

When all the documents are processed, the intermediate files are merged into a final index. Depending on the number of intermediate files, a pre-merge step may be performed. During the pre-merge phase, a subset of intermediate files is merged into creating larger intermediate files. Finally, the larger intermediate files will be merged into the final index and saved in index files 122.

Of note, the merged index provides a single consistent statistical basis for determining search result relevance when more than one collection and/or nodes is used in a search. In cases where a user selects more than one collection to run a search, the order in which indexes are merged can be selected.

During indexing, certain types of terms may have additional, special tokens added to an index that incorporate a range value for a term. This allows more rapid retrieval of an inverted list representing all values within a range.

Range Indexing

All commercial information retrieval (IR) systems use inverted files for query evaluation. An inverted file “inverts” a collection of documents in the sense that the content of the original documents is reordered to group words (or other indexing features) together—the original collection is in document order and the inverted collection is in word order. This organization facilitates query evaluation since only the inverted lists for words or features in the (possibly expanded) query need be examined to find matching documents, not the entire document collection.

However, the inverted files used in information retrieval systems have limitations. First, the main access abstraction used for inverted files is exact match—a specific word or indexing feature is matched in order to access inverted list information. Retrieval systems often support some sort of wild card or regular expression match (e.g., “dog*” to retrieve the terms “dog”, “dogs”, “doggedly”), but these expressions are expanded to the set of individual terms that “match” the expression. If there are n terms in the collection that start with “dog” then n inverted lists will be accessed and merged. Unfortunately, when many terms match the expression performance suffers.

Second, the inverted files used in conventional systems have very limited support for typed data—words or indexing features are generally interpreted as character strings.

In contrast, the embodiments of the present invention enable the concept of a range search and a range index, which is a new kind of inverted file.

Range searching makes use of a field abstraction. When a document collection is defined the set of elements that are to be range searchable are defined, each with a field name, an explicit data type, an explicit inverted list type (document id only, doc id plus word position, doc id plus word position plus length), and optional type-dependent information. Fields need not (but may) correspond to regions in a document. For example, an integer range field might be declared for weight. Any integer in the body of a document could be indexed as an occurrence of a weight field.

Significantly, each range field in a range index is explicitly typed. The field type determines what operators can be used in expressions involving that field. For example, since weight is an integer field expressions like “weight>100” or “weight between (50 100)” are allowed but “weight>dog” is not. The field types supported by the current implementation are integers, real numbers, geographic locations (latlongs), dates, and date/times. Other field types can be added.

Unlike standard inverted indexes, range indexes are accessed using range expressions rather than an exact match index term. In some embodiments, a range expression comprises of a field name, an expression operator, and zero to two type- and operator-specific operands. Operands are of a type that is consistent with the named field.

The result of evaluating a range expression using a range index is an inverted list in which each element corresponds to an occurrence of the named field in the document collection that satisfies the range expression. The content of an inverted list element depends on the inverted list type defined for the named field (doc id only, doc id+position, doc id+position+length).

Examples of some range expression operators are provided below:

| Operator | Alias | |
|---|---|---|
| Any | | Retrieve all elements of <field> |
| = | EQ | Retrieve all elements where <field> has a value |
| | | that equals operand |
| > | GT | Retrieve all elements where <field> has a value |
| | | greater than operand |
| >= | GE | Retrieve all elements where <field> has a value |
| | | greater than or equal to operand |
| < | LT | Retrieve all elements where <field> has a value |
| | | less than operand |
| <= | LE | Retrieve all elements where <field> has a value |
| | | less than or equal to operand |
| between (x y) | | Retrieve all elements where <field> has a value |
| | | greater than x and less than y |
| between [x y] | | Retrieve all elements where <field> has a value |
| | | greater than or equal to x and less than or equal |
| | | to y |

Examples of range expressions in use are

| language = “Chinese” | Retrieve all inverted list elements where the |
|---|---|
| | language field equals “Chinese” |
| weight >100 | Retrieve all elements for weight fields where the |
| | value is greater than 100. |
| classification any | Retrieve all elements for the classification field. |
| hired between | Retrieve all elements of the hired field (date) |
| [1990 1995] | between 1990 and 1995 (inclusive). |
| person = “John Doe” | Retrieve all elements the person field equals |
| | “John Doe” |
| altitude <20000 | Retrieve all occurrences of the altitude field with |
| | values less than 20000. |
| price between | Retrieve all occurrences of the price field with |
| (10.0 20.0) | values greater that 10.0 and less than 20.0. |
| event_time between | Retrieve all event_times with values between |
| [20080630:1200000 | noon and 1pm on 30 Jun. 2008 (time in |
| 20080630:1300000] | HHMMmmm format) |

In addition, the use of range predicates to increase the expressive power of range expressions may be employed by the embodiments. For example, a distance predicate for locations which computes the distance between the occurrence of a location field and a known location and a lower case predicate may be used to allow more flexible string matching.

In the embodiments, range searching are considered novel for at least two reasons. First, when documents are added to the collection a set of aggregate indexes are created to facilitate expression evaluation. The addition of aggregate indexes distinguishes a range index from a conventional inverted file. Second, when expressions are evaluated, the smallest set of terms necessary to cover a range expression can be computed. For example, a heap structure may be used to efficiently manage access to the lists for multiple satisfying terms.

Index Aggregation

When documents are added to the collection we create the normal inverted lists for each field:value pair encountered. For example, if the weight field has values 1..100, 100 inverted lists for each of the weights result since each inverted list contains all inverted list elements for occurrences of the weight field with value x. These low level inverted lists may be referred to as level zero lists or a level zero index.

The number of terms for each field can be quite large. When the number of terms for a field exceeds a field specific threshold, a set of intervals can be created to aggregate terms, which combine the inverted lists. These intervals generally are for a contiguous range of field values.

For example, the weight field might have inverted lists for weight:1, weight:2, . . . , and weight:100. These inverted lists together make up the level zero indexes for the weight field. If the number of component terms is sufficiently small then no higher-level aggregation is required. If the number of component terms at level n is large then a higher-level index is created at level n+1 that combines the inverted lists at level n. For example, a level one index for weight might have inverted lists for weight:1-9, weight:10-19, . . . , and weight:91-100. If the number of level one inverted lists gets too large then a level two index can be created, and so on.

Level zero indexes are created for all field:value pairs. Level n>0 indexes are then built directly from the level n−1 index and combine (aggregate) all postings information contained in level n−1. Note that each aggregation level indexes the entire collection so that each document and each inverted list element appear in every level. Of note, one benefit is that compression efficiency improves at higher levels.

The manner in which terms are grouped during aggregation can depend on the field type and the distribution of values for the specific field. For example, date fields might be aggregated by month at level one and then by year at level two. In one embodiment, an aggregation scheme creates a level n+1 index whenever the number of terms at level n exceeds aggregation_factor*min_terms_at_level. Where, each term at level n+1 will merge aggregation_factor level n terms. Choosing a large aggregation factor results in relatively shallow indexes with few aggregation levels and better storage utilization.

In order to evaluate a range expression, the minimal set of terms that cover the range expression must be determined and an efficient parallel access to the potentially large number of terms in that set may need to be evaluated.

Special range chunks can be helpful data such as date ranges, for which the original “chunking” tokens where constructed. Other field values may also be chunked such as, for example, a series of types determined for the document set, say “A” for “article” and “J” for “journal”, etc.

In some embodiments, indexing engine 112 and indexing files 122 may support various languages. For purposes of illustration, an example for Arabic normalized term indexing will now be provided.

Name Normalization: Arabic Names Example

There are two components to Arabic name processing: actual extraction of an Arabic name, and processing that Arabic name in a standard, meaningful way. When an Arabic name is found, either through extraction or field definition, it must be processed into a normalized form and stored to a text or field index.

In one embodiment, Arabic processing by indexing engine 112 involves the use of exception lists to eliminate candidates from processing (e.g. “Alice” shouldn't be turned into “Al ice”). Arabic name preprocessing is done to convert widely varying forms of a name into more standard format. For example, Abdelrahman may be found in variants such as Abdel Rahman or Abd al Rahman. Preprocessing by indexing engine 112 will put all of these forms into a standard Abd al Rahman before being converted to its final canonical form.

Once in final form, the name components are converted to double metaphone phonemes that are maintained in capital letters and prefixed with MET_in indexing files 122 to reduce the possibility of conflicts with similar, naturally occurring but non-Arabic name terms that could be present in a text. Thus the name Mohammed will be converted to MET_MHMT whether the actual name occurred as Mohammed, Mohamed, Mahamet, etc.

At query time, the user may be required to indicate that the name being searched should undergo Arabic name processing. In this instance, the extraction part of the process done during indexing is instead replaced with the name being typed in a special query box that indicates the name is Arabic and requires special processing.

For example, a general query from a user at user device 102 typed as {#arabicnorm(Mohamed)} would tell search engine 114 to perform Arabic processing on the term Mohamed before passing it to the query evaluator for document retrieval. This would cause the query to be transformed from Mohamed term to #LIT(MET_MHMT) at search engine 114, and all the variants of Mahommed found in the query context would be returned.

In order to rank the variants, middle tier 110 may rank Arabic variant system ranks hits as follows:

Exact matches rank above variant matches.

Full name matches rank above partial matches. For example, if your query is “Saddam Hussein Al Tikriti”, the name “Saddam Hussein Altikriti” will be ranked above “Saddam Hussein”, which will in turn rank above “Ali Hussein”.

Matches that maintain the order of query components rank above matches containing the same component names but in a different order. For example, if your query is “Saddam Hussein,” “Hussein Saddam” will also be retrieved, but it will be ranked lower on the results list than “Saddam Hussein”

Partial matches involving low frequency name tokens rank above partial matches involving more common name tokens. For example, if your query is Mohammed Shalgham, then Abderrahman. Shalgham will rank higher in the list of matches than Mohammed Atta. Particles like bin and al count even less in the match.

In one embodiment, encoded components are saved in indexing files 122 to the offset/length of the raw text. Thus, if “Bush” was reported at offset 100, length 4, all Arabic normalized components would end up being mapped to offset 100, length 4.

User Application Database: Collective Memory

User application database 124 to provide database storage of user queries and alerts, preferences, applied collections, saved folders and hits generated applications. During operation, nodes 108 attempts to log the source of all information that a user sees, plus it records additional information to make correlating audit log entries with each other and other logs easier.

For example, in some embodiments, the current day's entries are saved in user application database 124 to the file audit.log. At the start of a new day, when a new entry is about to be added to audit.log, the previous day's log is saved to the file auditlog.<date-stamp> and a new audit.log is created for the new day's data.

Examples of the specific information recorded to the audit log include:

Logins/logouts/new sessions/sessions expired:
a. Every user name used to attempt to log onto the system is logged.
b. Every user name that successfully logged in plus whether the user logged in using a local account or through another authentication means is logged.
c. The module that implements search also records the user name and session ID each time a user is granted a session to use the search interface.
d. When the session created to access the search module expires, the user name and session ID of the expired session are logged.
e. The module that implements saved queries records the user name and session ID each time a user is granted a session to use the saved query interface.
f. When the session created to access the saved query module expires, the user name and session ID of the expired session are logged.

Searches:
a. Each search submitted by a user logs the following information:
   i. the user name
   ii. the query
   iii. the collections searched
   iv. the total number of hits for the query
   v. whether the search returned partial results (at least one search server did not return results)
   vi. whether an error occurred during the search
b. For each set of search results shown to the user, the user name is logged along with information on each individual result shown on the results page. Regardless of how the results were computed (search, sorting, navigating through many pages of search results), each individual result item displayed on a results page has the following information logged:
   i. the hit number in the search results
   ii. the source URL of the document
   iii. the highlighted document URL
   iv. the collection to which the document belongs
c. If a user exports search results to a third party tool, the same information is saved that is recorded for a search (see item “a” in section “2 Searches”, above) is recorded:
   i. the user name
   ii. the query
   iii. the collections searched
   iv. the total number of hits for the query
   v. whether the search returned partial results (at least one search server did not return results)
   vi. whether an error occurred during the search
d. In addition, when a user exports search results to a third party tool, since all search results, up to a configured limit, are exported, the same information is logged for each result item as is logged when a result entry is displayed to the user on an html page:
   i. the hit number in the search results
   ii. the source URL of the document
   iii. the highlighted document URL
   iv. the collection to which the document belongs
e. If a user groups some number of search results, the user name is logged and for each individual search result item that is shown in the group display, the following information is logged:
   i. whether that document's information was expanded in the display (as opposed to only one field, the value of the field being grouped, being displayed)
   ii. the source URL of the document
   iii. the collection of the result
f. If a user views an original document or a cached/highlighted document for a search result, the following is recorded:
   i. the user name
   ii. whether the document was the highlighted document
   iii. the source URL of the document

Concepts knowledge discovery requests
a. When a user clicks on Discover Knowledge after running a query, the user name is logged. In addition, for each document used to extract the discover knowledge concepts, the following information is logged:
   i. the source URL of the document
   ii. the collection of the document
b. When a user views the concepts for a search, the user name is logged. In addition, for each document used to extract the concepts, the following information is logged:
   i. the source URL of the document
   ii. the collection of the document

Collection Browse Concepts
a. Each time a user views the browse concepts for a collection, the user name and the collection name are logged.

Saved Queries
a. When a saved query is run (through a schedule) to produce search results, the following information is logged:
   i. the user name of the saved query owner
   ii. the query
   iii. the collections searched
   iv. the limit date of the search (applies to profiles/agents only)
   v. the name of the Java class that the results are exported to, if any
b. When a saved query is run and saves results to a file to be downloaded by the user later, the user name of the query owner is logged. Plus the following information is logged for each search result item saved:
   i. the hit number in the search results
   ii. the source URL of the document
   iii. the highlighted document URL
   iv. the collection to which the document belongs
c. When a saved query is run and exports results to a third party tool, the user name of the query owner is logger. Plus the following information is logged for each search result item exported (the same as in item 2. above):
   i. the hit number in the search results
   ii. the source URL of the document
   iii. the highlighted document URL
   iv. the collection to which the document belongs
d. Each time a user views any search results of a saved query, whether it is a scheduled query or a profile/agent, the following is logged:
   i. the user name
   ii. the query
   iii. the limit date (relevant for profiles/agents only)
   iv. the collections searched
   v. the session ID
e. If the user views the saved query results using the ‘Show Hits’ interface, which uses an interface similar to the regular search interface, the user name is logged and for each individual search results displayed on a page, the following information is logged:
   i. the hit number in the search results
   ii. the source URL of the document
   iii. the highlighted document URL
   iv. the collection to which the document belongs
f. If the user manually exports the results of a saved query or agent search to a thirdly party tool by clicking the ‘Transfer Results’ button in the ‘Show Hits’ interface, then the user name is logged and for each search result item, the following information is logged:
   i. the hit number in the search results
   ii. the source URL of the document
   iii. the highlighted document URL
   iv. the collection to which the document belongs
g. If a user views an original document or a cached/highlighted document for a search result of a saved query, the following is recorded:
   i. the user name
   ii. whether the document was the highlighted document
   iii. the source URL of the document

Indexing Process

FIG. 2 illustrates an exemplary indexing process performed by indexing engine 112 of the present invention. If needed, an administrator may log in and initiate an index build after data source and index definitions are created. Some administrative tasks may include creating users, groups, permissions; defining data sources for index (web, ODBC, file); defining index parameters: data sources, build schedules, and actual build; and storing information as index records in human readable form in special directory.

Assuming these administrative tasks have been completed, in phase 200, source documents are converted into a form suitable for indexing. In phase 202, documents are obtained from directory, web or ODBC data repository from data sources 106. In phase 204, raw documents are converted into intermediate-form documents by converting binary formats (such as Word, PDF, xsl, etc.) to basic html form.

In phase 206, a canonical document is created. In particular, the intermediate files from extraction and translation are converted to final canonical form, which is suitable for indexing. Indexes from canonical file input are generated. The input text is tokenized and output to intermediate term list files. Concepts are then extracted from text and output to intermediate concept lists. Of note, concept extraction is also employed during analysis of search results using the user's query as a context and is described in more detail below.

The embodiments supports a number of extractors or scanners that are designed to recognize various types of concepts and index them ton index or dynamically extract and list them from a specified document or specified document. Concepts may be recognized by either an explicit definitions or with flexibly defined scanners or extractors. In general, the process of extraction can comprise the recognition of term or multi-term concepts, such as person name, date or credit card number that may reside in a provided text. In general, an extractor is a software module spawned by middle tier 110 that scans documents to find mentions of a particular entity or concept. For example, a person extractor may be configured to find mentions of people in the documents (like “Bill Clinton” or “Michael Jordan”) and a company extractor may find references to companies in the documents (like “Chiliad Publishing Inc” or “Ford Motor Co”). The following is a list of exemplary extractors employed by the embodiments.

noun

person

company

sentence

listdriven

date

location

city

diacritic

case

special

nonorm

phone

ssn

credit card

benum

latlong

regexlist

email

miscnum

drivers license

passportnum

dollar

arabicname

Below are listed some further details of some of the exemplary scanners. Some of these extractors may be inactive, but incorporated into the indexing engine 112 or search engine 114 and are available for activation.

Table 2 indicates for each extractor its purpose.

Concept

```
End of Sentences
  Find end of sentence locations.
Company Names
  Recognize company names and save in canonical form.
Person Names
  Recognize person names based on provided first and last name lists.
Dates
  Recognize many different forms of dates. All dates are stored in
  YYYYMMDD canonical form.
USA or Foreign Countries
  Finds instances of countries in a text buffer.
US Cities
  Extract city names based on a resource list that has been defined.
Acronyms
  Acronym recognizer.
Noun Phrases
  Noun phase scanner.
List Driven Concepts
  A list based recognizer.
Words with Diacritic Characters
  Extracts tokens with special diacritic characters.
Upper Case Words
  Index upper case tokens. Indexes both the upper case and lower cased
  versions of the string. Not generally used.
Special Dollar or Percent Values
  Indexes special dollar amounts.
No Normalization Tokenization
  A scanner that does the most basic tokenization on its buffer of text.
US Phone Numbers
  US phone numbers.
Social Security Numbers
  Social Security numbers in various forms.
Credit Card Numbers
  Credit card numbers.
Benum
  Scanner to recognize “Benums”. Form “9999-99999” or “9999E99999”
  where ‘9’ represents a number.
Latitude and Longitude
  Recognize latitude or longitude values in text.
Regular Expression List
  A regular expression recognizer.
Email Addresses
  Recognize various forms of email.
Miscellaneous Numbers
  A miscellaneous number recognizer.
Drivers License Numbers
  Identify driver's license numbers.
Passport Numbers
  Recognize passport numbers.
Dollar Amounts
  Recognize dollar amounts.
Arabic Person Names
  Recognizes Arabic names.
Facets
  Extractor used for defining facets extracted from structured and
  unstructured data.
IP Address
  Recognizes IP4 or IP6 formatted addresses.
Domain Names
  Domain names as defined in URLs, emails or by themselves.
```

Many extractors can be defined using lists. For example, a “US place” extractor has lists defining what legal streets may appear as, e.g. “Street”, “Avenue”, “Circle”, “Place”, etc. Similar lists can exist for general and foreign language, e.g., Arabic, person name components, company name components, and so forth.

Some recognizers require some initialization or termination work be done before the scanner is actually ready to be used. In some embodiments, “handlers” defined for each scanner may perform these necessary recognizer tasks. If a handler is defined for a scanner function, it will be called first before the actual recognizer function. It may also be called again when the recognizer is finished running on its provided buffer of text. Furthermore, recognizers or scanners may be customized to be unique to a particular organization, a user, etc.

Examples of scanner handlers are the “context” scanners such as the phone recognizer that loads a file of possible context phrases that may be used to indicate if a number in a text is a phone number or not, e.g. “Tel Num” or “Fax Number” appearing before the possible phone number string. These context phrases can be loaded from a definition file before the recognizer is run if context scanning is active.

Geospatial Extraction

Furthermore, the embodiments of the present invention may support geocoding of information. In particular, an extractor may be configured to call a geocoder to associate lat-long coordinates to the extracted places. In some embodiments, to be able to run the geocoder, a properties middle tier 110 accesses file. This file may be an ASCII file that contains a series of key-value pairs (one per line).

Geospatial information like addresses, cities, states, and countries are often buried in unstructured data. In order to enhance the productivity and efficiency of system 100, there is a need to discover geospatial concepts related to the query, organize large set of results across geospatial regions for discovery, analysis, and navigation, search for results within a geospatial region, organize the full collection across geospatial regions.

In some of the embodiments, there are two main parts to extracting geospatial entities: entity extraction, and geocode generation. First, once the addresses are recognized in text, the individual components are extracted for use in indexing and for geocode generation. These addresses are then normalized. Various known vendors provide address normalization and geocode generation. In some embodiments, APIs for geocoding are employed.

Tokenization

During the indexing process, a document text is divided up into various text fields of interest. These fields could be title, general text fields and various metadata fields such as a document ID or source path.

These fields are presented to various tokenizers, one field at a time, until the document is fully parsed. The parsing process involves initial tokenization of terms to be saved to the collection of field index. This generic tokenization also defines token positions that are later referenced from other tokenization processes, such as concept extraction, to allow a recognized concept to reside in clearly defined and consistent word positions in the document. This information is later used for proximity processing at query time and for document query term highlighting.

Concept Extraction

Among the tokenization processing on the currently active field of text are the concept extractors. If the field has been configured to run recognizers, each recognizer will run in its turn on the provided text, saving the concepts it finds along with the offset and length of the text that defines the concept. One may also explicitly define what string should be associated with an extracted concept.

For example for the text, “President Bush met Joe Smith on New Year's day, 2008,” the person name extractor might find “President George Bush” at offset 1204 and length 14. This name concept might be saved to the index as “President George W. Bush” even though that doesn't actually exist in the text. In addition, the date recognizer will note at offset 1236, length 20, a date concept was found. This concept would have been saved to the index as “20080101”.

Note that many concepts could reside at the same text location.

In the case of facet concept recognizer, the extractor saves values in a specified field to a facet index rather than a document or field text index. This information may be used for grouping of returned results after query evaluation.

In phase 208, intermediate term files are converted to normal and field based term indexes in indexing files 122. In phase 210, the intermediate concept files to concept indexes in indexing files 122.

Live Feed Indexing Example

In some embodiments, indexing engine 112 is configured to index data from a live-feed, e.g., from messaging services 120. As such, indexing engine 112 indexes a continuously updated data source periodically, such as every 15 minutes. The goal is to provide users and their profiles/agents access to the newest data along with the historical data for a given source.

The live-feed indexing assumes that the data source 106 is a file system source and that it has the source documents arranged in a directory hierarchy based on a date stamp. That is, the directory hierarchy has a set of directories for each month, in numeric format, and beneath each month should be directories for each day of the month. For example, a typical directory would be C:\<data source name>\2004\03\15\ . . . . The directory hierarchy may have additional levels of directories, but in this example the live-feed indexing only needs to know about the month and day directories.

As new documents arrive, they are placed in the directory hierarchy according to a date-stamp for the document. Indexing engine 112 then indexes the latest day's data; when data for a new day arrives, it starts indexing the new day's data. Thus, the data source must ensure that when a document arrives with a date-stamp that is for a new day, every document that arrives after that has a date-stamp of that new day.

According, for each live feed, there are seven daily indexes, each of which has a data source which points to the corresponding day in the source data's directory hierarchy. In addition, there is a large index that contains all, or at least the current year's, data for the source. The seven daily indexes and the large, cumulative index are placed in a single collection, which the user can query to search against all the data.

For example, the current day's daily index may be rebuilt every 15 minutes so as to include the latest documents that have been put into the data directory. The large index can be rebuilt each weekend. After the large index is rebuilt, the seven daily indexes have their corresponding data sources modified to point to the corresponding day in the next week, and the process repeats.

The daily index includes the corresponding two daily data sources. Why the daily indices have two data sources will be explained below.

The cumulative/yearly data source points to the full year's directory for the source data. The cumulative/yearly index contains the cumulative/yearly data source, and this index has the processed data from all the documents in the data source up to the time that the index started building.

In this example, indexing engine 112 builds the current day's index every 15 minutes. When a new day starts, the live-feed indexer builds the current day one last time and then moves on to the new day's data. When the new day is a Saturday, the live-feed indexer also starts a rebuild of the yearly index. When this rebuild is complete, the yearly index will include data from all documents in the year's data directory up to just after the beginning of Saturday.

The daily index requires two data sources because the large index is rebuilt each weekend. The daily indices need to store the data for the entire last week plus the data for the Saturday and Sunday (and possibly Monday) of the current week while the large index is rebuilding. Hence, once week plus three days of data sources are required to support live-feed indexing. Using two weeks of data sources makes the implementation easier.

After the large index is rebuilt, the data sources for the last week represent data that are now included in the large index. At this point these data sources can be advanced two weeks ahead to be the data sources for the next week. For example, given the mapping of daily data sources to directories given above, advancing the daily data sources for last week's data would result in daily data sources 106.

This advancing causes the _a and _b sets of data sources to leapfrog each other as the weeks progress. The actual changing of the data source dates occurs each Monday when the Monday data arrives.

Also each Monday each daily index (except Monday's) is rebuilt by a schedule in system 100. When the indices rebuild, the daily data sources for last week have already been advanced to next week (two weeks ahead). Rebuilding each daily index causes it to include the data from the two contained daily data sources, which contain data for the corresponding day this week and the corresponding day next week (which has no data). The old build of the daily index that contains data from the corresponding days from last week and this week will be replaced by the new build that only has data from this week and next. This rebuild is necessary to prevent duplicates from showing up in searches, since the cumulative index now contains the data from last week.

Search and Analysis Process

In overview, in some embodiments, the search process may occur over several phases in addition to the user's experience at user device 102. The processing occurs in real-time during execution of the distributed search and during filtering of new content. Each of nodes 108 is capable of performing these phases.

Access and Security Phase

During this phase the user's identity is verified and security protocols negotiated among systems to ensure that the user has permission to search any selected data sets. A final security check may be performed before delivering the final results to users, depending configuration settings in place at the time of the search.

Distributed Search, Filtering and Ranking Phase

Across all of the distributed nodes 108 that are involved in the search, items are analyzed and ranked based on the context of the user's query. Results are fused and analyzed across all participating nodes to create an initial ranking among all qualifying items.

Contextual Sub-Document Analysis Phase

Each retrieved item from the fused result set is analyzed to determine the most important passages in the context of the user's request. This results in a summary for each document relative to the user's area of interest. This passage ranking is used in the final relevance determination of the merged result set, as well as in the concept recognition phase.

“On the Fly” Semantic Tagging, Concept Recognition and Extraction Phase

In this phase, the nodes 108 analyze the content of each relevant section of each retrieved document to identify the part of speech of each term and to identify important phrases, concepts and metadata. The list of extracted and tagged concepts includes people, places, organizations, dates, account numbers, and dozens of other entities. Users can extend the list of concept “recognizers” at any time. Users receive two key benefits from real-time extraction.

First, the topics presented with the user's fused search results are weighted and ranked based on their relationship to the user's query and area of interest. In that way users are not overwhelmed with large numbers of concepts that are not pertinent to their investigation of search, while still receiving a comprehensive list of concepts. Second, as organizations add or refine their inventory of concept recognizers, these changes are immediately propagated and applied in future inquiries.

Presentation and Visualization Phase

All of the processing steps leading up to presentation yield a rich knowledge map that can be used for results viewing, conceptual navigation, collaboration and further analysis. Depending on system parameters set by the administrator, each of nodes 108 can record and store conceptual information about each user's search results and navigation patterns. This optional information can be used to connect users with other individuals interested in similar topics, as well as counter-intelligence in national security applications.

Referring now to FIG. 3A, this figure illustrates the distributed nature of the embodiments to support global knowledge fusion. In particular, as shown, a user issuing a query and analysis request that is processed by multiple instances of nodes 108 located in four different divisions. The user, who could be physically located anywhere, connects to an accessible instance of federator node 108.

Based on information sources selected by the user of configured by an administrator, the federator system sends the user's query to any “provider” systems that are accessible and needed to process the quest—in this case systems located in divisions C and B. Note that the node located at Division B functions both as a provider and as a federator, sending the query to the node located at Division D. The availability and even the existence of the node at Division D may be unknown to Division A. Depending on the user's identity, as well as other factors that can change day-to-day, access to any node, to any specific index on a node, and to any item residing on a node, can be controlled by an administrator with appropriate privileges.

Each of these distributed instances of the nodes 108 has access to one or more target stovepipe repositories and maintains up-to-date indexes based on data extracted from those repositories. The provider systems accessed in this example could be on the same network or located in different domains and at great distance from one another.

There is no limit to the number of nodes that can be connected in this manner or to the number of different systems whose content can be indexed and searched. Authentication of the user is handled initially by the federator system handling the user's request and then confirmed at each leaf node where the request is processed.

FIG. 3B then illustrates how system 100 provides for global knowledge fusion. As shown, the federator node 108 at Division A manages a fusion process that intelligently ranks and merges the results from each system into a single unified result set. This cooperative distributed processing provides a deep analysis that takes into account items retrieved by all of the participating nodes to ensure that the user receives the most relevant content across all of the distributed resources. The node located at Division B continues to fulfill both the provider and federator roles, managing fusion of items from Division D with the merged result set. This novel fusion method of the embodiments ensures that a particular document would be ranked identically regardless of which of the distributed systems it came from. This fusion is performed very efficiently, in real time, with minimal network activity, and without sending a single document or record across the network, if desired.

FIG. 3C further illustrates the flexibility and true peer-to-peer operation of the system. In this case there are two queries being processed. User 1 (as shown in the previous examples) has submitted a query to the federator node at Division A. That query, as shown, has been federated to Divisions C and B. Division B in turn federates the query to Division D.

User 2 now connects to a node at Division E. The query is sent to multiple providers, among them the system located at Division B, D and D. It is notable that B, C and D are all simultaneously processing the query issued by User 1. Division B, which acts as a provider to B and a federator to D, also performs that role in the query initiated at Division E. In each instance, the node at division B manages all of the communication with D.

As noted, while each node system is capable of functioning as a federator and a provider simultaneously, all of the roles and relationships, including which systems may be accessed as providers, which indexes are exposed to a particular federator, and other characteristics of the system, are under complete control of the administrator, or administrator who control specific servers or domains. In addition, individual nodes may be placed “online” or “offline” by local administrators, subject to organizational governance. This multi-host capability provides complete flexibility in deploying the system across an extended enterprise, as well as across agencies and trading partners.

During the fusion process, the participating nodes exchange information to create a single result set that contains the most relevant items from all available sources. Supporting this relevance model, there are multiple analysis phases that not only yield highly relevant results, but also create a rich conceptual map that supports navigation and knowledge discovery.

FIG. 3D illustrates further details related to an exemplary searching and analysis process of the present invention. As noted, system 100 provides a federated search that enables users to search across widely distributed data repositories without having to consolidate and manage all the data in a central repository. The search also globally ranks the results by relevance from various repositories and presents them in a unified result set. The individual nodes 108 will expose only those collections that are allowable for other nodes to search. As discussed below, the federated search results can also be presented within an ontology that is derived from the results or previously discovered.

In phase 300, a user via user device 102 submits a query. The query is then received at the appropriate node 108. There are several types of queries defined by their syntax that reside in different locations. Low Level queries are represented by a very rich low level query syntax that resides in the retrieval engine. All queries eventually end up translated at search engine 114 to this syntax. The syntax defines terms and structure operations (AND, OR term proximity, etc). Upper or “Simple Syntax” queries may have simplified language that resides at the UI level in user device 102. The user can use NEAR or quoted phrases for term proximity, AND and OR operators, equal sign for literal, etc. In addition, the user's query may comprise the use of one or more wildcards to specify the data requested. For example, wildcard characters supported may include: an asterisk “*” for 0 or more characters; a question mark “?” for 1 character; or a pound symbol “#” for 1 numeric character.

In phase 302, search engine 114 parses the query, converts high-level user query language to low level structured language, if needed. Stop or stem terms are determined, if appropriate and terms expanded, as needed. For example, name normalization may be used in the search. As another example, nickname expansion function is available for use to determine first names that include nicknames that might otherwise not be obtainable for query term expansion. For example, the search for a first name of “Robert Smith” may want to include documents containing “Rob Smith” or “Bob Smith”, etc. In phase 304, search engine 114 creates a query net encapsulating query terms and structure operators and query transformations. In phase 306, search engine 114 evaluates the query. For example, the appropriate nodes 108 may recursively evaluate query net nodes based on term statistics in collection indexes. These nodes 108 return a list of document scores based on query terms and structure.

In phase 306, nodes 108 present a retrieval summary and convert the belief list into document titles, scores and best passages for user review at user device 102. In some embodiments, in phase 308, document listings are ordered by score with highest scoring documents at top of list.

In phase 310, the user may view selected documents with query terms highlighted to better show document relevance to query. The user may also view the original or indexed version of document. For example, the original document could be non-text file form, such as PDF, Word, spreadsheet, etc.

As noted, system 100 is capable of providing a global ranking of results. This global ranking is performed based on score normalization during merge, query evaluation and document summary construction, the viewing of individual documents and the extraction of concepts from documents or document sets. The global ranking process comprises several phases, which are performed by the middle tier 110.

Since documents and scores may be arriving from multiple indexes/collections on different hosts 104A-N, the results will be globally fused into a single result for presentation to the user by one of nodes 108.

In addition, search engine 114 may analyze and organize the fused results as using facets. A facet is a named type associated with documents that can take on a range of values. For example, as noted above, these types could be a date, person's weight or document classification level. A facet has a data type associated with it. For example, types in use for facet data are integers, strings and a special facet type referred to as “latlong” referencing a geographic position in latitude and longitude value pairs. The facet types and values are stored in a special keyed index in indexing files 122 for rapid retrieval.

The retrieval may be by value or range of values. Facet instance counts may also be returned to the user.

One benefit of document facet definitions is to provide criteria for further grouping of an original returned document set for a relevant user query. Search engine 114 may provide a list of facet types and values alone with the respective document counts for each facet value or value range. Users may then select facet value or value range of interest which adds the selected facet criteria to the original query, producing documents within the original document set that contain the selected facet criteria.

For example, a user query on “truck bombs” retrieves a perhaps very large set of documents. To better focus this set of retrieved documents, the user may select facet types and values associated with this particular set of documents. This could be a latlong type facet providing geographic position information for the “truck bomb” documents. Selecting such a facet for a specified facet value range, say western Europe, would return documents about truck bombs the also mention locations, as defined by a latlong type facet, in western Europe value range.

Facets are defined by text field name and extraction type. If a specified text field of a document contains information values or ranges of values of interest, the user can define the field as a facet of type string, int or latlong. A facet extractor will take values from the field, and store it in a facet index for later access. Running tallies are kept in the indexing files 122 of the numbers of facets, document counts and instances during the document indexing process. This information may be dynamically retrieved at query time, to provide the values, value ranges and document counts for each facet of interest during document retrieval.

Geospatial Facets

In certain kinds of analysis, the fused search results have to be organized based on geo-spatial attributes. Conventionally, most geospatial search solutions map only the top N documents. Since there can be vast number of search results, a solution that enables the user to know the distribution of the search results across geospatial co-ordinates may be very productive. This also enables analysts to discover new fused geo-spatial concepts so that users can drill down further to narrow down the results. The challenge in such a problem is the fact that there are vast numbers of search results and the geospatial concepts have to be retrieved for all the documents in result set and organized in a meaningful way. Also, these results have to be generated quickly enough to be useful in an interactive application.

Accordingly, the embodiments provide a unique solution that organizes the large number of search results in a meaningful way by grouping the documents into geospatial regions. The size and number regions can be dynamically controlled by the mapping application.

Knowledge Discovery

Optionally, the user at user device 102 may request further analysis and ask that system 100 provide its discovered knowledge. For example, the user may click on a “Discover Knowledge” button or option on a web page displayed at user device 102. Accordingly, types of extracted concepts found in the retrieved document set may be displayed. In addition, the user may be allowed to expand original user query with selected concept terms.

If knowledge discovery has been requested, the middle tier 110 will request the nodes to dynamically extract concepts “on the fly” relevant to user's query.

The application can generate a new query based on the original query and user selected concepts offered up to the user and selected by them for reapplication to the search engine to more closely focus the retrieval evaluation.

Knowledge discovery may also employ top concepts from indexing files 122. Top concept extraction may be specified at index configuration time to extract the top most concepts for the entire index. In one embodiment, it is a separate process spawned by middle tier 110 that stores the top most concepts and frequency counts in a special file. Its purpose is to help characterize an index by allowing user browsing of the most frequent concepts and concept types in a collection.

Concept Extraction from Search Results

For example, search engine 114 may scan the results using the user's query as a context to identify concepts within the search results. In particular, the search engine 114 may use a context sensitive scanner that validates a concept candidate by testing whether it lies within some distance from a context phrase, such as portion of the user's query. Context phrases are strings that indicate the candidate token is indeed a relevant concept being searched for by the scanner. For example, a context phrase for concepts like driver's license number might be the appearance of the phrase “Drivers Lic #” some distance before (or after) the actual driver's license number.

Accordingly, system 100 can precisely define context phrases and then to use them to validate concept patterns when they are found in text of search results. Therefore, even imprecisely defined concepts may be identified and extracted by the embodiments.

In some embodiments, context phrases can be used as regular expression (RE) patterns to further enhance precision during concept extraction.

For example, driver's license numbers may be recognized based on the following definitions:

1-12 numbers.

E.g. “1” “123456765432”

Single leading alpha followed by numbers or alphanums, perhaps with separators.

E.g. “A123” “D 12345678901234” “A-R123456-Z” “AT123456S”

Two leading alphas followed by alnums.

E.g. “AB123456S”

Leading digits followed by alpha nums.

E.g. “12 ABC 12345” “123AB1234” “1234567A”

Nine alphanumerics in pretty much any order.

E.g. “A12B5ZY12” “1AB5Z12Y2”

Based on the above definitions, the context for a driver's license may be:

Driver's License

Driver's License (Number|Num|No|#)

License (Number|Num|No|#)

License (ID|Identification)

License (ID|Identification) (Number|Num|No|#)

Because they are defined in a separate concept file in index files 122, they can be added to or modified with ease without recompilation. In some embodiments, a pattern file may be used and have a set of parameters. These parameter definitions may define whether context phrase validation is on or off, the size of a text window within which a context pattern is searched, and whether the context window size is applied backwards or forwards or to both sides of the current concept candidate found by the flex scanner used by search engine 114.

For a concept candidate to be validated, a match of at least one of the context phrases should exist within the window of text defined above. A match thus means the concept is validated and saved to the index.

Filtering and Alerts

FIG. 4 illustrates an exemplary filtering and alerting process by filtering engine 118 of the present invention. Document “filtering” is the process of determining if a document is relevant to a defined user query. Documents that match queries are “filtered” from an incoming set of documents and the user of the query is “alerted” that a document of interest to him has arrived. In addition, various alerts can be triggered based on filtering.

Typically, a document to be filtered is part of a stream of incoming documents. There may be a large number of documents coming in which a user cannot always take the time to examine as they arrive. According, a user may create “alert” or query (or set of queries) that defines his information needs.

Unlike ad hoc document search, the queries for a filtering application are predefined, and thus already resident in memory when documents inputs arrive. There is no predefined document index containing term statistics, so these statistics are developed on a per query basis.

Documents can be brought into the filtering engine 118 via messaging services engine 120 either as a “push” or by a “pull”. are provided.

Once the document has been received, it is evaluated against all queries. If the evaluation score is greater than some defined minimum score threshold, the document is considered a “hit”, or relevant to the applied query.

Filtering engine 118 may make use of the same query structure operators as used by the normal search performed by search engine 114. These operations allow user definition of term proximity, term requirement or rejection criteria, and presence or absence requirements.

Hits are accumulated in the hits data structure. The hit data structure includes the query ID used in evaluating the document, the evaluation score and match information (location/length) of query terms that matched against the document. If specified, most relevant passage rankings are generated.

The end result will be a list containing the query IDs, scores and query term match information for all queries whose scores equaled or exceeded the score threshold for the document just processed.

Use of Ontologies to Enhance Knowledge

In some embodiments, ontologies are provided to assist in the knowledge discovery by the user. Ontologies are helpful in searching across or navigate through disparate data repositories that are widely distributed across different parts of an organization or across organizations. Ontologies enables to navigate widely distributed diverse data repositories. If the content has meta-data associated with them, then they can be navigated based on the meta-data attributes. Some examples of these are “content-type” like Images, Documents, Audio, etc.

Much of the implicit knowledge revealing an ontology exists in the text of the document, which will not be available in the meta-data. The ontology provides terminology that describes the content. Based on domain knowledge, queries can be associated to the ontology nodes that will enable users to navigate and search for relevant content. This allows even users who are not domain experts to effectively search and navigate the content.

Conventional search techniques are unable to represent the search need to effectively search. For example, it is not possible to describe a terrorist person in conventional queries. In contrast, the system 100 may extract semantic concepts out of content and represent them in the indexes. Extractors for different ontology nodes can be built with the assistance of domain experts using heuristics, rules, and lists. These semantic concepts could then be associated with ontology nodes among nodes 108.

Ontology discovery may have several benefits. For example, when searching on large repositories, users tend to use simple queries to represent their need. Generally many thousands of possible hits are retrieved. Presenting the results in an appropriate ontology will enable the user to better comprehend the huge set of results.

A simple way to present the results within ontology is by using the meta-data associated with the content. For example, the results could be displayed in a content-type ontology.

Another feature presents the results within the ontology based on the semantic knowledge extracted from the full-text content. In this case, grouping is based on the semantic concepts extracted from the documents.

A high-level representation of a document collection stored on hosts 104A-N or search results can be presented within an ontology. This may allow users to understand the content of the collection and will enable users to navigate and perform further search and analysis.

Document content can also be represented within an ontology. For example, if “BioAgent” is one of the ontology categories, system 100 may also show how the instances of BioAgent occur in a document having terms like ricin or napalm. Furthermore, users can add alerts on meta-data, full text or ontology concepts or a combination of them to be notified when new content relevant to the alerts are added.

Knowledge Collaboration

As users analyze documents and discover knowledge through normal use of system 100, system 100 summarizes, logs, and tracks the knowledge that each authenticated user is accessing throughout one or more nodes 108. These automatically acquired knowledge summaries comprise the “collective memory” of the analysis system 100. This is an effective and unobtrusive technique developed to date to find experiential ‘experts’ with whom to exchange critical tacit knowledge. More than any technique developed to date, this feature provides an effective capability to locate those individuals likely to have the rest of the knowledge that a user is trying to find in a particular context, across an enterprise or across multiple organizations.

In some embodiments, this technique also provides a discerning counterintelligence capability. This system can effectively identify users most highly associated with a suspected activity or conversely, analyze and summarize the specific knowledge acquired by suspect users. The software automatically tracks and remembers each document accessed by each user, providing the knowledge of all of the eyes that have been on any particular document and all of the documents accessed by a particular set of eyes. These capabilities can be combined with the intelligent filtering agents in filtering engine 118 for continuous monitoring of network traffic to produce instant alerts as users are querying the system 100.

Another benefit of this feature is helping users find other people with similar interests and expertise. As people are using system 100, data will be collected such as, the search query, the results set returned (including best passages, document referenceID, document data source, etc), the document viewed and its best passage, the user that did the action, the time of day (timestamp), the collections searched, etc. This information may then be used for retrospective search and filtering/alerts to find people with similar interest and to find what people are searching on.

For example, if a user is working on a type of device and in particular the device and it's characteristics, the collective memory of system 100 may indicate who else in the bureau has issued queries similar or have found out information on these types of devices.

Another example, if a user is working on a case about shootings in DC involving a particular high power rifle and particular mode of operation, then the collective memory of system 100 may indicate the other people in other areas of the country that might have queried or seen reports similar to this case

For counterintelligence, data about that have viewed particular documents on a certain date, or to find people that have asked specific questions about various subjects may be collected into system 100. Once the person is found, the filtering engine 118 may be configured to perform an analysis and monitoring to find out what other documents the user has viewed, or what other queries that this user has searched on.

As noted, the collective memory is based on the auditing and information stored in user application database 124 described above. For example, when a user runs a search, the username, the query, the results set (including document references and best passages), timestamp, the collections searched, etc. may be collected. When a user opens a document for viewing whether it may be the cached (or highlighted document) or original document, again the username, the document reference and document source, the associated query, the timestamp, etc may be collected. When a user moves a document to a folder, the username, timestamp, document reference, etc., this event may also be captured since this information can also be used for explicit relevance feedback, i.e. if it good enough to move to a folder, then it must of have been a good hit.

Searching for people with similar interest can be initiated with or without running a search. For example, if after running a regular search and results are returned, users may have the option of finding others with similar interest. If selected, a result page will be presented with the title links of username and a best passage of the information that they have seen. Based on security policies, a user may also select a title and a document about this person with their contact information will be presented.

Although the foregoing invention has been described in terms of certain embodiments, other embodiments will be apparent to those of ordinary skill in the art from the disclosure herein. Moreover, the described embodiments have been presented by way of example only, and are not intended to limit the scope of the inventions. Indeed, the novel methods and systems described herein may be embodied in a variety of other forms without departing from the spirit thereof. Accordingly, other combinations, omissions, substitutions and modifications will be apparent to the skilled artisan in view of the disclosure herein. Thus, the present invention is not limited by the embodiments, but is to be defined by reference to the appended claims.

1. A computer-implemented method of indexing content in a document collection, wherein a set of elements are defined for the document collection and each element comprises at least one range field having a range of terms, the method comprising:
determining a first range index that indicates a list of terms belonging to a range field having a specified type indicating allowable operators that can be used in expressions involving terms that are within the range field and indicates respective documents in the document collection; and
determining an inverted, aggregate index based on the first range index that aggregates at least a portion of the range of terms into a list of aggregate terms belonging to the range field and respective documents in the collection into a hierarchical arrangement grouping the range of terms into a plurality of hierarchical levels.

2. The method of claim 1, wherein the range field comprises a data type that specifies operations and expressions that may be applied to terms of the range field.

3. The method of claim 2, wherein the range field comprises integer terms.

4. The method of claim 2, wherein the range field comprises floating point number terms.

5. The method of claim 2, wherein the range field comprises alphanumeric character string terms.

6. The method of claim 2, wherein the range field comprises terms that indicate a date.

7. The method of claim 2, wherein the range field comprises terms that indicate a time.

8. The method of claim 1, wherein determining the aggregate index comprises:
determining when a number of terms of the range field exceed a threshold; and
creating the aggregate index when the number of terms exceed the threshold.

9. The method of claim 8, further comprising determining a threshold based on a predetermined minimum number of terms of the range field and a predetermined aggregation factor.

10. A method of searching for information in a document collection, wherein a set of elements are defined for the document collection and each element comprises a range field having a range of terms and a specified data type indicating allowable operators that can be used in expressions involving terms that are within the range field, said method comprising:
receiving a query for information from the document collection;
accessing, based on a range expression comprising operators that are compliant with the specified data type for the range field, at least one range index that indicates a list of terms belonging to the range field and respective documents in the document collection and at least one inverted, aggregate index that is based on the at least one range index and aggregates terms in the range field into a hierarchical arrangement grouping the range of terms into a plurality of hierarchical levels; and
providing a set of results based on the range index.

11. The method of claim 10, wherein the range expression requests all terms of the range field.

12. The method of claim 10, wherein the range expression requests terms that equal a specified operand.

13. The method of claim 10, wherein the range expression requests terms greater than a specified operand.

14. The method of claim 10, wherein the range expression requests terms less than a specified operand.

15. The method of claim 10, wherein the range expression requests terms that are between a set of specified operands.

16. The method of claim 10, wherein the aggregate index comprises a first index that comprises an inverted list of terms and a second index that comprises an inverted list of aggregated terms derived from the first index, and further comprising:
determining a minimum set of terms that satisfy the range expression; and
determining an interval in the second index that at least partially satisfy the range expression.

17. The method of claim 16, further comprising determining an interval in the first index for terms that cannot be satisfied by the interval in the second index.
